(19) United States
(12) Patent Application Publication
(10) Pub. No.: US 2002/0186766 A1
(43) Pub. Date: Dec. 12, 2002

(54) Device for image encoding and decoding

(76) Inventor: Joseph Adelaide, Creteil (FR)

Correspondence Address: U S Philips Corporation, Intellectual Property Department, 580 White Plains Road, Tarrytown, NY, 10591, US

(21) Appl. No.: 09/914,243

(22) PCT Filed: Dec. 22, 2000
(86) PCT No.: PCT/EP00/13205

(30) Foreign Application Priority Data
Dec. 29, 1999 (FR) 9916682

(51) Int. Cl. H04N 7/12

(52) U.S. Cl. 375/240.2; 375/240.12

(57) ABSTRACT

A device for image encoding and decoding is implemented as follows. There is an incomplete encoding circuit (ENCI) for effecting, inter alia, a DCT transform, a quantization and a variable-length encoding. There is an incomplete decoding circuit (DECI) for effecting, inter alia, a variable-length decoding. Moreover, there is a complementary circuit (CC) for effecting, inter alia, an inverse quantization, an IDCT transform and a motion compensation. A control circuit (CTRL) enables the complementary circuit (CC) to cooperate with the incomplete encoding circuit (ENCI) and the incomplete decoding circuit (DECI) in order to effect encoding and decoding, respectively. The complementary circuit (CC) is arranged to operate in accordance with different modes of an encoding standard. Accordingly, the incomplete decoding circuit (DECI) and the complementary circuit (CC) can, in combination, decode recordings which have been made in accordance with different modes of an encoding standard.

### FIELD OF THE INVENTION

The invention relates to a device for image encoding and decoding, for example in accordance with an MPEG standard (MPEG is an acronym for Motion Picture Expert Group). The invention can be used in, for example, a DVD apparatus (DVD is an acronym for Digital Versatile Disk).

### BACKGROUND OF THE INVENTION

A circuit for encoding has functions which can be employed for decoding. For example, an MPEG encoder comprises functions such as an inverse quantization, an IDCT transform (IDCT is an acronym for Inverse Discrete Cosine Transform) and a motion compensation.

A device for encoding and decoding images can thus be implemented in the following manner. The device comprises;

an incomplete encoding circuit for effecting, inter alia, a DCT transform, a quantization and a variable-length encoding;

an incomplete decoding circuit for effecting, inter alia, a variable-length decoding;

a complementary circuit for effecting, inter alia, an inverse quantization, an IDCT transform and a motion compensation;

a control circuit for making the complementary circuit cooperate with the incomplete encoding circuit and the incomplete decoding circuit in order to effect encoding and decoding, respectively.

The device can be applied in a camcorder for making video recordings in accordance with a specific MPEG-2 mode. That is, the incomplete encoding circuit and the complementary circuit effect, in combination, an encoding in accordance with the specific MPEG-2 mode. The incomplete decoding circuit and the complementary circuit effect, in combination, a decoding in accordance with the specific MPEG-2 mode. U.S. Pat. No. 5,703,651 appears to disclose such a camcorder.

### SUMMARY OF THE INVENTION

It is an object of the invention to provide a greater user satisfaction.

The invention takes into consideration the following aspects. As mentioned hereinbefore, the prior-art camcorder is arranged to operate in accordance with a specific MPEG mode. It can not be excluded that a user of the prior-art camcorder wishes to play back a recording which has been made by means of another camcorder. It can neither be excluded that the other camcorder is arranged to operate in accordance with an MPEG mode different from the MPEG mode in accordance with which the first-mentioned camcorder operates. If this is the case, the user can not play back the recording which has been made by means of the other camcorder.

In accordance with the invention, the complementary circuit identified hereinbefore is arranged to operate in accordance with different modes of an encoding standard. Accordingly, the incomplete decoding circuit identified hereinbefore and the complementary circuit can, in combination, decode recordings which have been made in accordance with different MPEG modes. Consequently, a user of a recording and playback apparatus in accordance with the invention, such as, for example, a camcorder, will have a better chance of being able to play back a recording made by means of an other apparatus than his own. Consequently, the invention provides a greater user satisfaction.

The invention will be described in more detail hereinafter with reference to the drawings.

### BRIEF DESCRIPTION OF THE DRAWINGS

FIG. 1 illustrates the characteristic features of the invention as claimed in claim 1.

FIG. 2 shows an example of a device in accordance with the invention.

### DESCRIPTION OF EMBODIMENTS

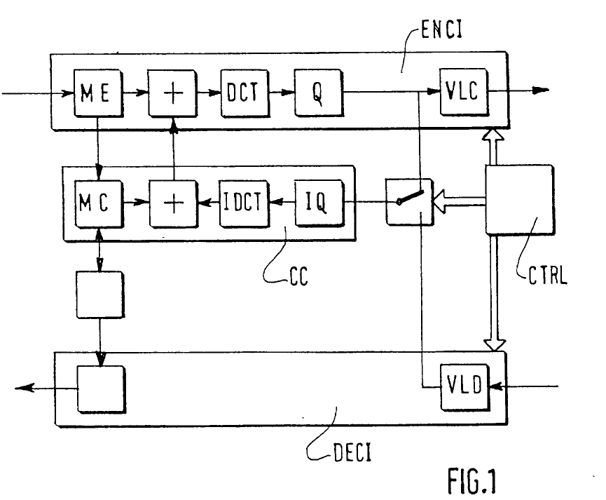

FIG. 1 illustrates features on which the invention builds. A device for image encoding and decoding is implemented in the following manner There is an incomplete encoding circuit ENCI for effecting, inter alia, a DCT transform, a quantization and a variable-length encoding. There is an incomplete decoding circuit DECI for effecting, inter alia, a variable-length decoding. Furthermore, there is a complementary circuit CC for effecting, inter alia, an inverse quantization, an IDCT transform and a motion compensation. A control circuit CTRL enables the complementary circuit CC to cooperate with the incomplete encoding circuit ENCI and the incomplete decoding circuit DECI in order to effect encoding and decoding, respectively.

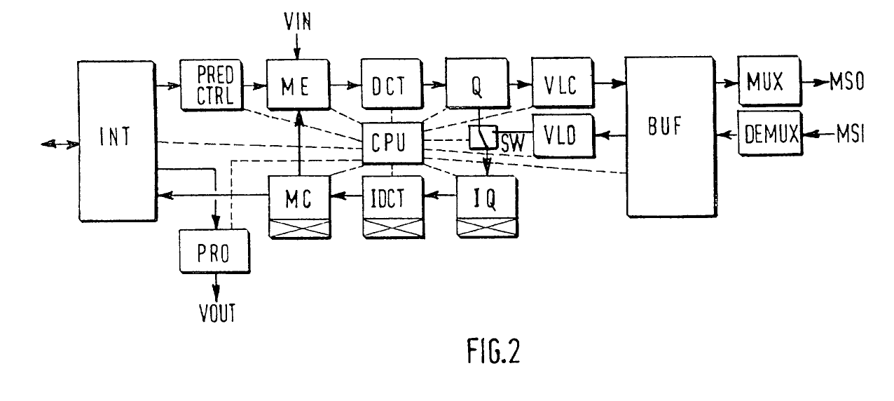

FIG. 2 shows an example of an integrated circuit for image encoding and decoding in accordance with the invention. The integrated circuit can receive a video signal VIN to be encoded and can supply, in response thereto, an encoded video signal MSO in the form of an MPEG data stream. The integrated circuit can also receive an encoded video signal MSI in the form of an MPEG data stream and can supply, in response thereto, a decoded video signal VOUT.

The integrated circuit has a memory interface INT, a prediction controller PREDCTRL, a motion estimator ME, a transform circuit DCT, a quantizer Q, a variable-length encoder VLC, a buffer memory BUF, a multiplexer MUX, a demultiplexer DEMUX, a variable-length decoder VLD, an inverse quantizer IQ, an inverse transform circuit IDCT, a motion compensator MC, and an image processor PRO. These elements as well as their operation are known per se. The integrated circuit further includes a switch SW and a controller CPU.

The general operation of the integrated circuit is as follows. The controller CPU allocates operational parameters to the various elements. Moreover, it defines the position of the switch SW. If the position of the switch SW is as shown in FIG. 2, the integrated circuit operates in the encoding mode. If the position of the switch SW is opposite to that shown in FIG. 2, the integrated circuit operates in the decoding mode. In this case, the controller CPU can deactivate various elements such as, for example, the transform circuit DCT, the quantizer Q and the variable-length encoder VLC. The inverse quantizer IQ, the inverse transform circuit IDCT and the motion compensator MC are arranged so as to operate in accordance with different modes of the MPEG standard. They include additional parts in comparison with the situation that they are used only for encoding, which in principle requires only one mode. These additional parts are represented as a rectangle in which a cross is shown.

The table below illustrates operating parameters of the motion compensator MC for different MPEG modes.

| MPEG mode | MC operating parameters |
|---|---|
| MP@HL frame_rate_code:[1:8] | Picture_size: 1920 × 1152 |
| | f_code:[1:9] |
| MP@ML frame_rate_code:[1:5] | Picture_size: 720 × 576 |
| | f_code:[1:8] |
| MP@LL frame_rate_code:[1:5] | Picture_size: 352 × 288 |
| | f_code:[1:7] |

The controller CPU sends control signals to the motion compensator MC so as to cause the motion compensator MC to operate in accordance with one of the MPEG modes.

The integrated circuit cooperates with an external memory, which is not shown in FIG. 2, via the memory interface INT. This external memory serves for the temporary storage of partly or fully decoded images and reference images required by the motion estimator ME. In this respect, it is to be noted that the rectangle without any text in FIG. 1, which does not belong to the incomplete decoding circuit DECI, may represent such a memory. In that case, the other rectangle without any text in FIG. 1, which belongs to the incomplete decoding circuit DECI, corresponds to the image processor PRO.

The integrated circuit shown in FIG. 2 is particularly suitable for use in a DVD apparatus (DVD is an acronym for Digital Versatile Disk). In such an application, a recording is made is the following manner. The integrated circuit receives video data to be recorded via an input circuit. In response, the integrated circuit provides encoded video data. The encoded video data is applied to an error-protection circuit which, in response, provides error-protected encoded video data. The error-protected encoded video data is applied to a laser-driver circuit. In response, the laser-driver circuit applies a laser-input signal to a laser. The laser provides a modulated laser beam which modifies the properties of an optical disk so as to make an optical recording. A playback is effected in the following manner. An optical read-arrangement sends a laser beam to an optical disk and receives a reflected beam from the disk. The optical read-arrangement provides a read signal in response to the reflected beam. An error-correction circuit provides encoded video data in response to the read signal. The integrated circuit receives the encoded video data and provides decoded video data in response which video data is applied to an output of the DVD apparatus via an output circuit.

The above Figures and their description illustrate rather than limit the invention. It is evident that there arc numerous alternatives within the scope of the appended Claims. In conclusion, some remarks are made in this respect.

The functional entities or functions can be allocated in many different ways. In this respect, it is to be noted that the Figures arc highly diagrammatic, each Figure representing merely a single embodiment of the invention. Thus, although a Figure shows different functional entities as separate blocks, this does not exclude the fact that a plurality of functional entities are presented as a single physical entity.

Finally, any reference signs given in parentheses in a claim shall not be construed as limiting said claim. The use of the verb “to comprise” does not exclude the presence of elements or steps other than those defined in a claim. The use of the indefinite article “a” preceding an element or step does not exclude the presence of a plurality of these elements or steps

1. A device for image encoding and decoding comprising:
an incomplete encoding circuit (ENCI) for effecting, inter alia, a DCT transform, a quantization and a variable-length encoding;
an incomplete decoding circuit (DECI) for effecting, inter alia, a variable-length decoding;
a complementary circuit (CC) for effecting, inter alia, an inverse quantization, an IDCT transform and a motion compensation;
a control circuit (CTRL) for making the complementary circuit (CC) cooperate with the incomplete encoding circuit (ENCI) and the incomplete decoding circuit (DECI) in order to effect encoding and decoding, respectively. characterized in that the:
the complementary circuit (CC) is arranged to operate in accordance with different modes of an encoding standard.

2. A recording and playback apparatus comprising a device as claimed in claim 1.
